(19) United States
(12) Patent Application Publication
(10) Pub. No.: US 2018/0228265 A1
(43) Pub. Date: Aug. 16, 2018

(54) LICE TOOL CLEANER

(71) Applicant: Pam Skinner, Huntington Beach, CA (US)

(72) Inventor: Pam Skinner, Huntington Beach, CA (US)

(21) Appl. No.: 15/430,172

(22) Filed: Feb. 10, 2017

(51) Int. Cl. A45D 24/44; B08B 1/00; B08B 3/08; A46B 5/00

(52) U.S. Cl. CPC A45D 24/44; B08B 1/002; A45D 24/30; A46B 5/0041; A46B 5/0004; B08B 3/08

(57) ABSTRACT

A system, device, and a method are provided for cleaning tools, for example a nit comb. A cleaning device may be part of a cleaning system and may include one or more cleaning surfaces configured to make contact with some or all parts of the tool that is to be cleaned. The cleaning surface(s) may include a multiplicity of strands or bristles that are configured to fit in a space between portions of the tool to be cleaned, for example, between the tines of a nit comb. A tool to be cleaned may be passed or drawn along one or more portions of one or more cleaning surfaces of the cleaning device. Various cleaning devices and methods for using the cleaning devices are also described.

### BACKGROUND

Ectoparasites, including lice, fleas, etc., can infest and feed on human hosts and cause various problems for the host, including discomfort, irritation, and itching. For example, head lice (Pediculus humanus capitis) are insects that infest the heads of humans and grow to about the size of a sesame seed. Once in hair, the head lice lay eggs or “nits” in the hair of the host. The nits are small greyish-white oval-shaped eggs glued at an angle to the side of a hair shaft. A nymph may hatch from each egg or “nit” and grow and develop to an adult louse. Head lice infestations involve the colonization of the head or scalp of a host by the lice. Head lice feed on blood from the scalp and can cause irritation and itching for the host. Head lice are often spread to new hosts through direct head-to-head contact with an infested person or by sharing personal articles such as hairbrushes, combs, nit combs, or the like.

Treating ectoparasite infestations and/or head lice infestations may involve the application of topical treatments, including hair washing, or the application of lotions, oils, or the like. Manual removal of eggs/nits and ectoparasites/lice may also be used. An ectoparasite/lice/nit comb (e.g., a microgrooved metal nit comb) might be used to make manual removal of ectoparasites and eggs easier. To be most effective at removing eggs, a comb may beneficially have multiple, closely spaced tines, or teeth, which will remove the ectoparasites/lice and eggs/nits as it passes through hair.

It is important that any comb that may be used to remove ectoparasites/lice and/or eggs/nits should be cleaned. Preferably, cleaning should occur between successive passings/combings through the hair and certainly between uses (e.g., between multiple uses on one person or between uses by different people), so that lice and nits are not spread inadvertently. Proper use of a comb to thoroughly remove an infestation may be a slow, methodical process, with each stroke taking careful measures not to contaminate others. The combing process could take many hours to properly comb out an infestation while continually cleaning the comb. A plurality of combs could possibly be used in one treatment in order to lessen the time consumption of cleaning the comb, involved therein, but this would require a large number of combs per client, each of which would need to be cleaned between clients.

In terms of cleaning a comb, merely wiping the comb on a towel or using a single string to clean in between each pair of tines of the comb would be very inefficient and time consuming and would require many passes or wipes in order to fully clean the comb. There is a need for systems, devices, etc. that allow for more quickly and efficiently cleaning combs and/or other tools/instruments used in conjunction with treating ectoparasite infestations (hereinafter, “lice tool,” though this term should not be considered as being limited to tools used only for lice, as tools/devices used for treating other ectoparasite infestations (e.g., fleas) on humans and animals are intended to be included), e.g., an ectoparasite, lice, flea, nit, and/or egg comb, so that all the ectoparasites, lice, fleas, eggs, and/or nits may be removed and cleaned off the lice tool with a minimum of effort.

### SUMMARY

This summary is meant to provide some examples and is not intended to be limiting of the scope of the invention in any way. The description herein relates to systems, methods, devices, apparatuses, instruments, tools, services, etc. that may be utilized for cleaning. Various features and steps as described elsewhere in this disclosure may be included in the examples summarized here.

Examples of embodiments of, and enhancements for, systems, devices/apparatuses, methods, etc. used for cleaning equipment, devices, apparatuses, instruments, tools, systems etc. are described herein. In one embodiment, the cleaning systems including one or more cleaning devices may be used for cleaning tools/instruments, e.g., tools used for ectoparasite infestations, head lice infestations, flea infestations, or the like.

In one embodiment a cleaning system including one or more cleaning devices and/or a cleaning device for cleaning a tool (e.g., a lice tool, comb, brush, other tool, etc.) may comprise a first portion (e.g., a lower portion) and a second portion (e.g., an upper portion) configured to engage the first portion. The cleaning system/device may include any of the features or components described or encompassed elsewhere in this disclosure. In one embodiment, the cleaning system/device may also include a cleaning surface (e.g., a first cleaning surface) configured for cleaning the tool (multiple cleaning surfaces are also possible), wherein the cleaning surface comprises at least one of bristles and strands (or both), and wherein the cleaning surface is configured to engage the tool. The second portion may include a first opening, and the cleaning surface may be configured to engage the tool when the tool is passed through the first opening. The second portion may also include a second opening, and a second cleaning surface (different from the first or other cleaning surface) may be configured to engage the tool when the tool is passed through the second opening. In one embodiment, the first opening and/or the second opening may be between 3 and 25 centimeters long and between 0.25 and 20 cm wide, between 5 and 15 centimeters wide and between 0.25 and 10 centimeters wide, or other lengths and widths.

In one embodiment, one or more openings (e.g., the first opening and/or the second opening) may be configured/sized to closely fit the tines of a lice comb therethrough (e.g., long and skinny like the cross section of a lice comb) or may be larger. The first cleaning surface may include multiple strands that extend across the first opening, and the multiple strands may be arranged parallel to each other or at angles to each other. The tool may be a lice comb, comb, brush, or other tool that includes multiple tines, and the multiple strands may be spaced relative to each other such that when the lice comb is inserted through the first opening, at least one strand of the multiple strands passes between each pair of tines of the multiple tines. In one embodiment, the multiple strands may be connected to a frame or cartridge that is enclosable between the first portion and the second portion. The cleaning system/device may include a fluid that contacts the cleaning surface. The fluid may be similar to other fluids/liquids described herein, e.g., it may comprise chemicals for killing ectoparasites. In one embodiment, the cleaning surface may be movable or rotatable in one or more dimensions, and this may be automated or manually done.

In one embodiment, the first portion may be hingedly attached to the second portion. The cleaning surface may be at least one of a brush and a comb. The first portion may be movable relative to the second portion from a first closed position to a second open position. In the second open position, the first portion may be angled between 10 and 90 degrees, 30 and 70 degrees, or a different angle relative to the second portion. The tool may be a lice tool, and the cleaning surface may be configured to engage the lice tool. The lower portion may be configured as a collection container that is able to collect materials dislodged from the tool during cleaning.

A method for cleaning a tool may comprise obtaining a cleaning system or cleaning device including a first cleaning surface comprising bristles, multiple strands extending across an opening, and/or any other features/components described elsewhere in this disclosure. The method may include drawing the tool (one or multiple times) across the first cleaning surface. With multiple strands, the tool may be drawn across the first cleaning surface such that multiple surfaces of the tool contact different strands of the multiple strands. The tool may be a lice tool with multiple tines, and drawing the tool across the first cleaning surface such that multiple surfaces of the tool contact different strands of the multiple strands may include drawing the lice tool across the first cleaning surface such that the different strands of the multiple strands pass between different pairs of tines of the multiple tines. The cleaning system/device may include a second cleaning surface comprising multiple bristles, multiple strands, etc., the method may include drawing the tool across the first cleaning surface and then drawing the tool across the second cleaning surface. This may include rotating, twisting, and/or pulling side to side the tool to cover and clean more surface area. At least one of the first cleaning surface and the second cleaning surface may further include a liquid thereon that may be similar to other fluids described herein (e.g., it may include chemicals for killing ectoparasites), and drawing the tool across the first cleaning surface or drawing the tool across the second cleaning surface may include bringing the tool into contact with the liquid. Other steps described elsewhere in this disclosure may also be used with various devices, components, features, etc.

### BRIEF DESCRIPTION OF THE DRAWINGS

The disclosed devices/apparatuses, systems, methods, etc. may be better understood with reference to the following drawings. The components in the drawings are not necessarily to scale.

FIG. 1 illustrates a side view of an exemplary embodiment of a first cleaning device, according to the present disclosure.

FIG. 2 illustrates a plan view of an exemplary embodiment of a cleaning device, according to the present disclosure.

FIGS. 3A and 3B illustrate side views of an exemplary embodiment of a cleaning device, according to the present disclosure.

FIG. 4 illustrates a plan view of an exemplary embodiment of a cleaning device, according to the present disclosure.

FIG. 5 illustrates a perspective view of an exemplary embodiment of a cleaning device, according to the present disclosure.

FIG. 6 illustrates an exploded view of an exemplary embodiment of a cleaning device, according to the present disclosure.

FIG. 7 illustrates a close up view of an exemplary embodiment of a cleaning device, according to the present disclosure.

FIG. 8A illustrates a plan view of an exemplary embodiment of a cleaning device, according to the present disclosure.

FIG. 8B illustrates a side view of an exemplary embodiment of a lice tool cleaning device, according to the present disclosure.

FIG. 9 illustrates a plan view of an exemplary embodiment of a cleaning device, according to the present disclosure.

FIG. 10A illustrates a plan view of an exemplary embodiment of a cleaning device, according to the present disclosure.

FIG. 10B illustrates a side view of an exemplary embodiment of a cleaning device, according to the present disclosure.

FIG. 10C illustrates a front view of an exemplary embodiment of a cleaning device, according to the present disclosure.

FIG. 11A illustrates a plan view of an exemplary embodiment of a cleaning device, according to the present disclosure.

FIG. 11B illustrates a side view of an exemplary embodiment of a cleaning device, according to the present disclosure.

FIG. 11C illustrates a front view of an exemplary embodiment of a cleaning device, according to the present disclosure.

While the present disclosure is subject to various modifications and alternative forms, specific embodiments thereof have been shown by way of example in the drawings and will herein be described in detail. Like references indicate similar elements. The invention should be understood to not be limited to the particular forms disclosed, but on the contrary, the intention is to cover all modifications, equivalents, and alternatives falling within the spirit and scope of the present disclosure. It will be appreciated that the current illustrations are not limiting in their scope and that various features illustrated in different embodiments may be combined within a claimed embodiment.

### DETAILED DESCRIPTION

The following description and accompanying figures, which describe and show certain embodiments, are made to demonstrate, in a non-limiting manner, possible configurations and steps of systems, devices/apparatuses, and methods for the cleaning of lice tools, including but not limited to nit combs, ectoparasite combs, flea combs, other devices, and the like. While the description herein, by way of example, is focused primarily on a description of cleaning tools for use in treating head lice infestations in humans, the systems, devices/apparatuses, methods, etc. described herein are not so limited and may be applied to tools for treating other types of insect/ectoparasite/other infestations (even if not involving lice). Further, while infestations of the head are primarily discussed herein, the systems, devices/apparatuses, methods, etc. described herein are not so limited and may be applied to infestations in areas other than a host's head (i.e., infestations in other treatment areas of an animal's body). Infestations that may be treated with the systems, devices/apparatuses, methods, etc. described herein may be on animal hosts (e.g., humans, dogs, other animals), or may be infestations in a variety of other locations. Further, while the description herein, by way of example, is focused primarily on a description of cleaning tools for use in treating infestations, the systems, devices/apparatuses, methods, etc. described herein are not so limited and may be applied to a variety of types of tools, e.g., the cleaning devices herein may be used for cleaning combs/brushes used by hair stylists, salons, or other companies/persons or for cleaning other types of tools that may for example, have multiple tines or something similar. Accordingly, the inventive principles associated with the embodiments described herein, may be applied to tools used for other embodiments and purposes, e.g., to clean tools used for other types of infestations or systems, devices/apparatuses, tools, methods, etc. used for other purposes.

In the following description, numerous specific details are set forth in order to provide a thorough understanding of the present disclosure. However, the invention disclosed herein may be practiced without these specific details. In other instances, specific numeric references may be made, for example, to a “first” component, brush, etc. However, the specific numeric reference should not be interpreted as a literal sequential order but rather interpreted that, for example, the “first brush” is different from a “second brush,” unless otherwise indicated. Further, where various options within or between embodiments are presented, it will be understood that contemplated embodiments may include all permutations of these options. By way of a non-limiting example the phrase “at least one of bristles and strands” will be understood to include embodiments that have either, “bristles”, or “strands”, or both “bristles and strands”. Thus, the specific details set forth are merely exemplary. The specific details may be varied from and still be contemplated to be within the spirit and scope of the present disclosure. The term “coupled” is defined as meaning connected either directly to the component or indirectly to the component through another component. Further, as used herein, the terms “about,” “approximately,” or “substantially” for any numerical values or ranges indicate a suitable dimensional tolerance that allows the part or collection of components to function for its intended purpose as described herein.

For clarity it is to be understood that the word “proximal” refers to a direction relatively closer to a user using the device to be described herein, while the word “distal” refers to a direction relatively further from the user. For example, the end of a device closer to the body of a client is considered a distal end of the device, while the device end closer to the user is a proximal end of the device. Also, the words “including,” “has,” and “having,” as used herein, including the claims, shall have the same meaning as the word “comprising.”

According to various embodiments, the objectives described above and elsewhere herein may be accomplished by providing an improved system for cleaning tools used for ectoparasite infestations, including but not limited to nit combs. The present disclosure provides a system including a device for cleaning tools used for ectoparasite infestations, or “lice tools,” and a method associated with the system.

In an exemplary embodiment, the system may include at least one or multiple specially designed cleaning surface(s) for cleaning the lice tool. The cleaning surface may include a specially designed brush, ‘floss’ system having a multiplicity of strands (e.g., a multiple floss system or simultaneous floss system), or combination thereof for cleaning the lice tool. In an exemplary embodiment, the bristles of the brush or the multiple strands of the floss system may be configured to fit between the tines (or multiple pairs of tines) of a nit comb, thereby removing any nits, lice or debris disposed thereon.

In an exemplary embodiment, the cleaning device may include a pair of cleaning surfaces. By way of a non-limiting example, the pair of cleaning surfaces may include brushes, sets of bristles, a floss system as described herein, or a combination thereof, positioned opposite each other.

In an exemplary embodiment, the cleaning device may be configured so that at least a portion of the lice tool may contact a portion of the cleaning surface. In an exemplary embodiment, the cleaning device may be configured so that substantially the entire lice tool may contact a portion of the cleaning surface.

In an exemplary embodiment, the cleaning device may include a fluid to assist with the cleaning of the lice tool. The fluid may be disposed within a container that is associated with the cleaning surface, the fluid may be disposed on the cleaning surface, the fluid may be disposed in a housing of the cleaning device and may be dispensable onto the cleaning surface (e.g., by pressing a button, switch, etc. on the housing), the fluid may be disposed in other places that might be useful, etc., or a combination of these. By way of a non-limiting example, the fluid may include water, detergents, soaps, solvents, pesticides, natural solutions that kill ectoparsite, heated fluids/liquids, etc., or a combination of these.

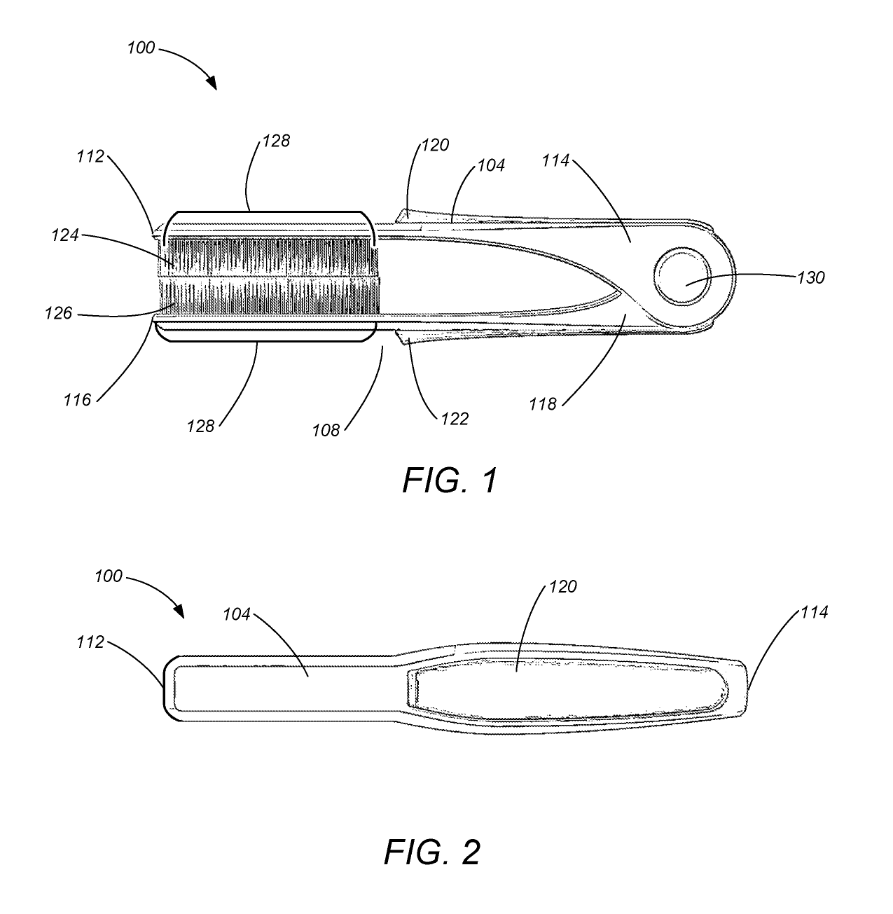

FIGS. 1 to 4 illustrate an exemplary embodiment of a cleaning device 100. The cleaning device 100 may include a first portion 104 and a second portion 108. Each of the first and second portions 104,108 may include a distal end 112, 116 and a proximal end 114, 118. The first and second portions 104, 108 and/or the proximal ends 114, 118 of the first and second portions 104,108 may be attached to one another via a hinge 130 or other suitable component to enable mutual movement therebetween. The first and second portions 104,108 may be attached at either of the proximal or distal ends. The hinge 130 may include a living hinge or variations thereof, without departing from the scope of the present invention. The cleaning device 100 may include a latch, clasp or similar device (not shown) for attaching the first and second portions 104,108 together so as to prevent the first and second portions 104, 108 from separating either during use or between uses.

In an exemplary embodiment, each of the first and second portions 104, 108 may include grips 120, 122. The grips 120, 122 may be formed as part of the first and second portions 104,108 or the grips 120, 122 may be made of a different material possessing different physical properties. In an exemplary embodiment the grips 120, 122 may comprise of silicone rubber or similar material that provides improved grip and comfort properties compared with that of the first and second portions 104, 108. The grips 120, 122 may also be shaped and sized in an ergonomically or aesthetically pleasing form. The grips 120, 122 may also include logos, symbols, or alphanumeric codes depicting the brand, or details pertaining to the cleaning device itself. By way of a non-limiting example, the codes may disclose a specific type of brush with bristles that are capable of fitting between the tines of a specific type of nit comb. It will be appreciated that such logos, symbols, or alphanumeric codes may also be located on any portion of the cleaning device without departing from the spirit of the invention.

In an exemplary embodiment, each of the first and second portions 104, 108 may include one or multiple cleaning surfaces. The one or multiple cleaning surfaces may include brushes, bristles, sponges, wipes, etc. For example, a cleaning surface or two cleaning surfaces may include a first and second brush 124, 126. Each of the first and second brushes 124, 126 may include, for example, a multiplicity of bristles 128 aligned substantially parallel with one another and perpendicular to a surface of the first and second portions 104, 108. The bristles 128 may comprise individual strands of nylon, or similar material, of a size and shape that allow the bristles to fit between the tines of a nit comb. It will be appreciated that the bristles 128 may be made from other materials, aside from nylon, that possess different physical properties. It is also contemplated that each individual bristle may vary in properties such as strength, flexibility, stiffness, length, diameter, or cross-sectional shape so as to provide a cleaning surface best suited for different types of lice tools. The first and second brushes or if more brushes are used, may be formed in a variety of shapes and sizes and, while they may include bristles, may also or alternatively include other types of materials and surfaces, e.g., sponges, wipes, cloth, textured surfaces, and more.

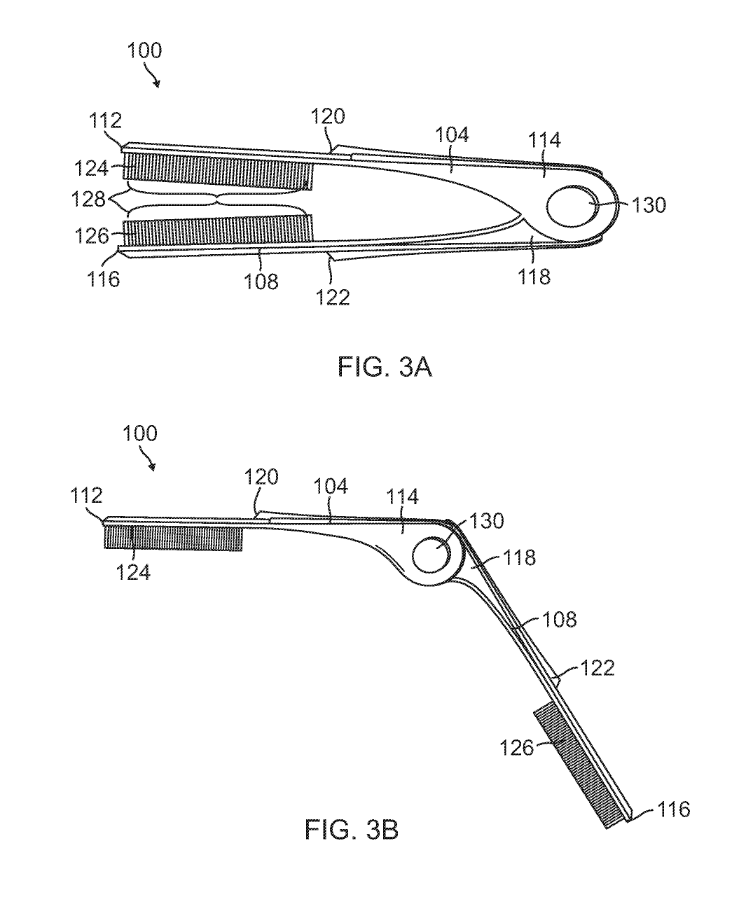

FIGS. 3A and 3B illustrate a side view of the cleaning device 100, wherein the first and second portions 104, 108 are shown in a separated, or open, configuration. In an exemplary embodiment the first and second portions 104, 108 are movable about the hinge 130 from a first, closed or substantially/mostly closed, position to a second, open or substantially open, position. As shown, by way of a non-limiting example, in FIG. 1, the first position may be where a portion of the first brush 124 is in contact with a portion of the second brush 126. As shown, by way of a non-limiting example, in FIG. 3A, the second position may be where the first brush 124 and second brush 126 are separated by a space or at an angle with respect to each other (e.g., an angle between 10 to 90 degrees relative to each other). It is contemplated that the first and second portions 104, 108 may also be moveable to a third position (e.g., a widely opened position), as shown, by way of a non-limiting example, in FIG. 3B where the first and second portions 104, 108 are angled relative to each other at an angle of 90° or greater. The device may include a lock, latch, button, etc. that might need to be toggled/engaged to allow the device to transition to the third position (or other positions). The third position may facilitate periodic cleaning of the cleaning device 100. In an exemplary embodiment the hinge 130 may include a mechanism (not shown) that allows movement between a first, second and third position as desired by the user. Other positions at different angles are also possible.

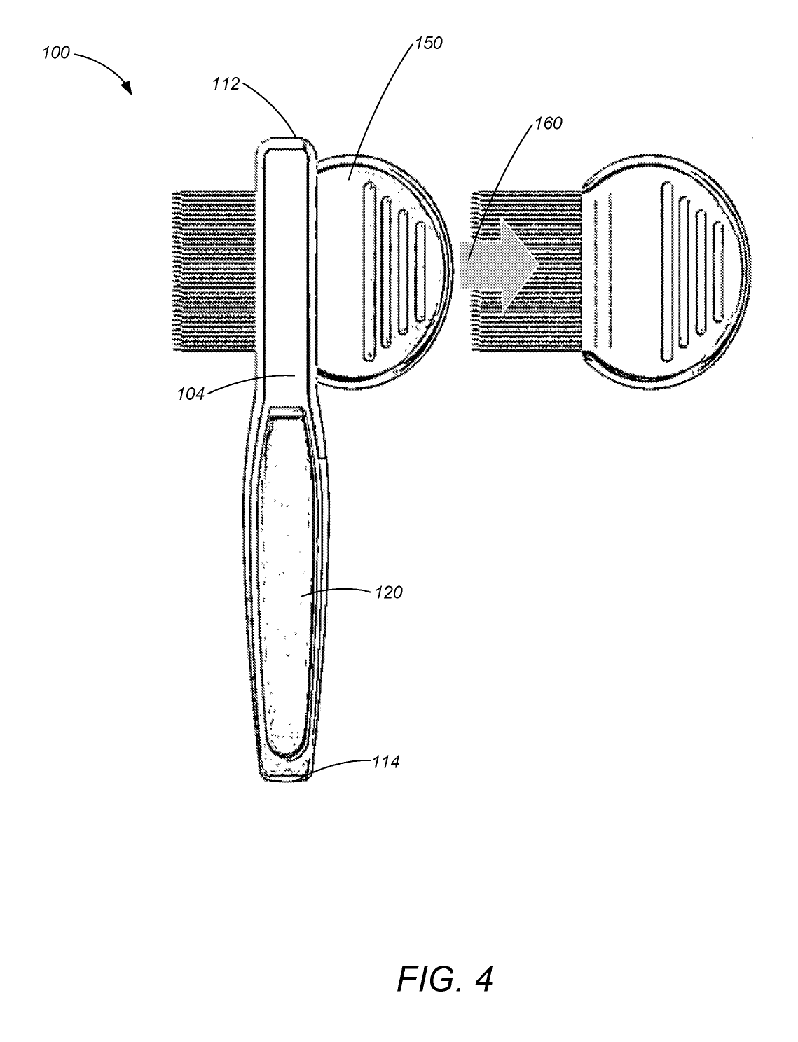

In an exemplary method of use, the cleaning device 100, at rest, may be biased towards the second position, as best shown in FIG. 3A. A lice tool 150, such as, by way of a non-limiting example, a nit comb, may be placed between the first and second brushes 124, 126. The hinge 130 may be sprung so as to bias the cleaning device 100 towards the second position. A user may then apply pressure to the outside surfaces of the first and second portions 104, 108 to overcome the force of the sprung hinge 130 and move the first and second portions 104, 108 to a first position. If not biased or no spring is used, the first and second portions 104, 108 may just be moved into a desired position, e.g., a first, closed position. In the first position, bristles 128 of the first and second brushes 124, 126 close around the lice tool. As previously described above, the properties of the bristles may vary, however, in an exemplary embodiment the bristles may be configured so as to fit around the contours of the lice tool 150, or between the tines of a nit comb. As best shown in FIG. 4, while maintaining the cleaning device 100 in a first position, the user may draw the lice tool 150 in the direction shown 160, through the brushes 124, 126 so as to remove any nits, eggs or other debris collected by the lice tool 150. While the device is configured so that only a single draw of the lice tool is needed, the process may be repeated as necessary. Insertion of the lice tool in the opposite direction of 160 could also be done or movement of the lice tool in a single direction relative to the cleaning device may be done. Periodically, the cleaning device 100 itself may need cleaning, in which case it is contemplated that the cleaning device 100 includes a mechanism (not shown) that allows the cleaning device to be moved from a second position, as shown in FIG. 3A, to a third position, e.g., as shown in 3B. In the third position the inside surfaces of the first and second portion, including the brushes 124, 126 may be more readily accessed to facilitate cleaning of the cleaning device 100.

It is contemplated that the cleaning device 100 may include other forms of cleaning surfaces, such as pads, toweling, comb-like structures, others described herein, or combinations thereof. In an exemplary embodiment, the cleaning surface may include a comb-like structure, (not shown). The comb-like structures may be positioned similarly to the first and second brushes 124, 126 and may consist substantially of a row of tines. By way of a non-limiting example, the tines may be sized and spaced so that they are capable of fitting between the tines of a nit comb. The tines of the comb-like structure may be made of nylon or similar material that may possess suitable physical properties in rigidity, strength, flexibility, or the like. It is contemplated that each cleaning surface on the first and second portions 104, 108 may include different forms, by way of a non-limiting example, a comb-like structure may be disposed on the first portion while a second brush 126 may be disposed on the second portion 108. Similarly a comb-like structure may be disposed on a first portion 104 while a pad or toweling may be disposed on a second portion 108. It will be appreciated that other combinations of cleaning surfaces are contemplated without departing from the spirit of the invention.

In an exemplary embodiment the cleaning surface of the cleaning device 100 may include a multiplicity of strands where one end of each of the strands is attached to the first portion 104 and the other end of each of the strands is attached to the second portion 108. It is contemplated that the hinge 130 may be a sprung hinge, living hinge, or the like, so as to maintain tension on the strands. Each of the multiplicity of strands may be sized and spaced so as, by way of a non-limiting example, to fit between the tines of a nit comb. The strands may be configured similar to exemplary embodiments described herein.

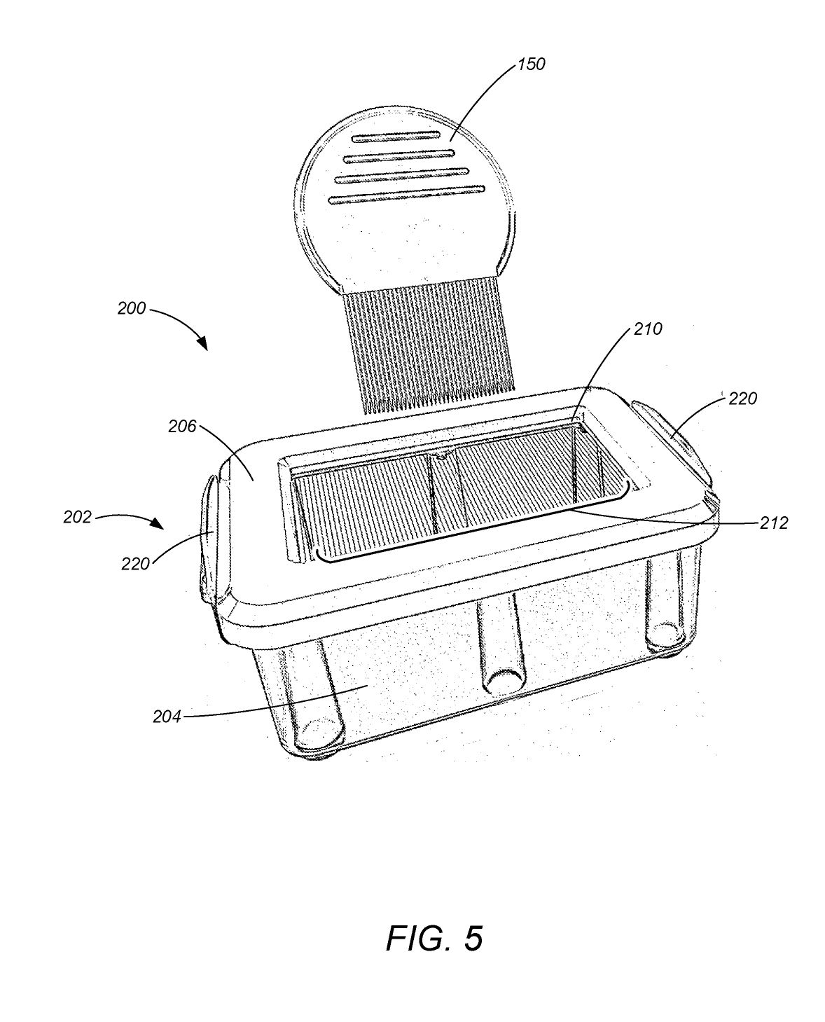

FIGS. 5 through 7 illustrate an exemplary embodiment of a cleaning device 200. The cleaning device 200 may comprise substantially a box or container 202 that may include multiple portions (e.g., a first, base portion 204 and a second, upper portion 206. The upper portion 206 may be configured to engage the base portion 204 to create a seal therebetween. The cleaning device 200 may include at least one or multiple (e.g., two) latches 220 or similar securing device to hold the base portion 204 and the upper portion 206 together. Unclasping the one or more latches 220 may allow opening the device and/or separating components for cleaning the cleaning device 200. The cleaning device 200 may include at least one or multiple (e.g., 2-8) footing(s) 222. The footing(s) may be made from the same or a different material than that of the cleaning device 200. By way of a non-limiting example, the footing(s) 222 may be made from a silicon rubber, while the base portion 204 may be made from a more rigid plastic, such as, by way of non-limiting examples, polystyrene, polycarbonate, polyvinyl chloride (PVC), high density polyethylene (HDPE), low density polyethylene (LDPE), polypropylene (PP), or the like, or a similar material that displays suitable physical properties. The footing may advantageously prevent the cleaning device from sliding on a work surface.

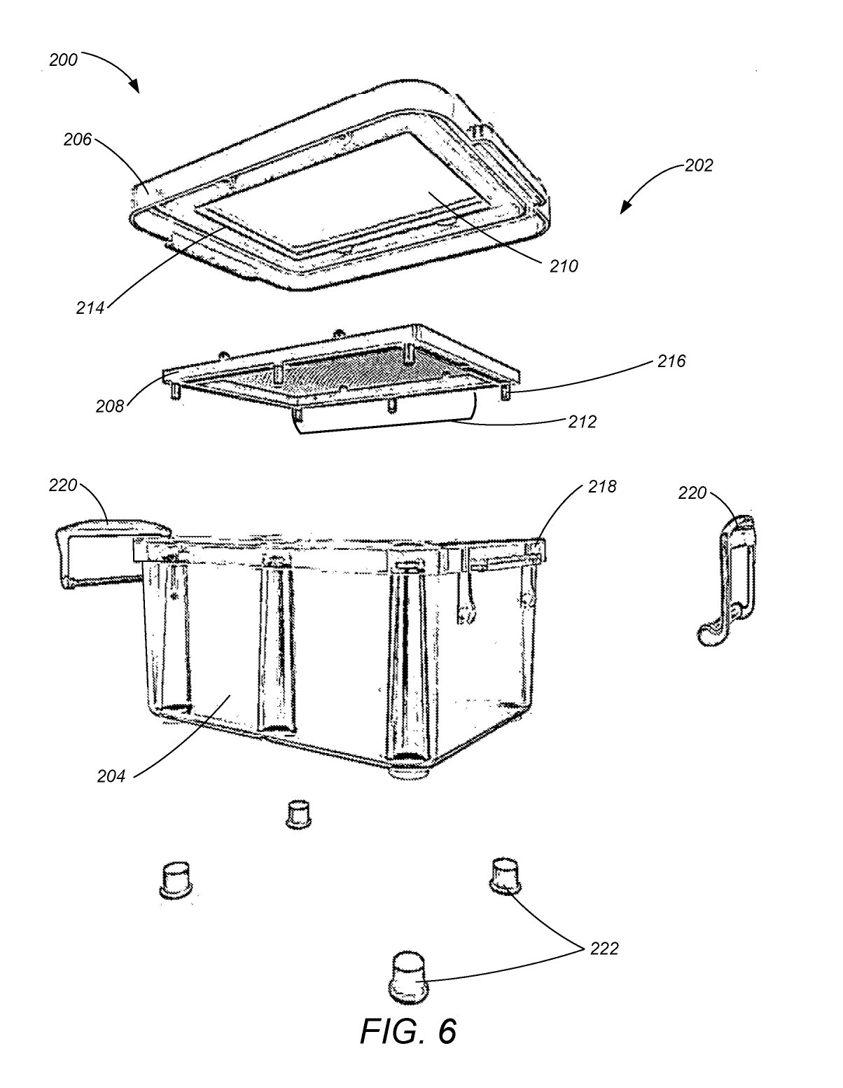

The upper portion 206 may include an opening 210. The upper portion 206 may also include a multiplicity of strands 212, e.g., spanning the opening 210, which may be constructed and arranged in similar ways to the strands described elsewhere herein. Having multiple strands is significantly easier to use than a single strand would be, including because it allows cleaning between multiple tines at the same time and is much more efficient and time-effective. In an exemplary embodiment, as best seen in FIG. 6, the strands may optionally be disposed in a separate cartridge or frame 208. The frame 208 may be configured to fit with the upper portion 206 so that the strands 212 align with and/or cover the opening 210. In an exemplary embodiment the frame 208 may be disposed between the upper portion 206 and the base portion 204. In an exemplary embodiment at least one or both of the upper portion 206 or base portion 204 may include a rim 214 or edge that abuts against a portion of the frame 208. In an exemplary embodiment, the frame 208 may include at least one or multiple (e.g., 2-10) post(s) 216. The post (s) 216 may be configured to be disposable within a housing 218 disposed on at least one or both of the upper portion 206 or base portion 204. The configuration of rim(s) 214, edges, and post(s) 216 may vary between the frame 208, upper portion 206, or base portion 204 without departing from the spirit of the invention.

In an exemplary embodiment, the frame 208, upper portion 206 or base portion 204 may be made from the same/similar materials or different materials that display different physical properties. By way of a non-limiting example, the frame 208 may be made from a silicon rubber, while the upper portion 206 and base portion 204 may be made from a more rigid material, such as described herein. Accordingly, the frame 208 may be compressed between the upper portion 206 and base portion 204 and provide a substantially leak-proof seal between the upper portion 206 and base portion 204.

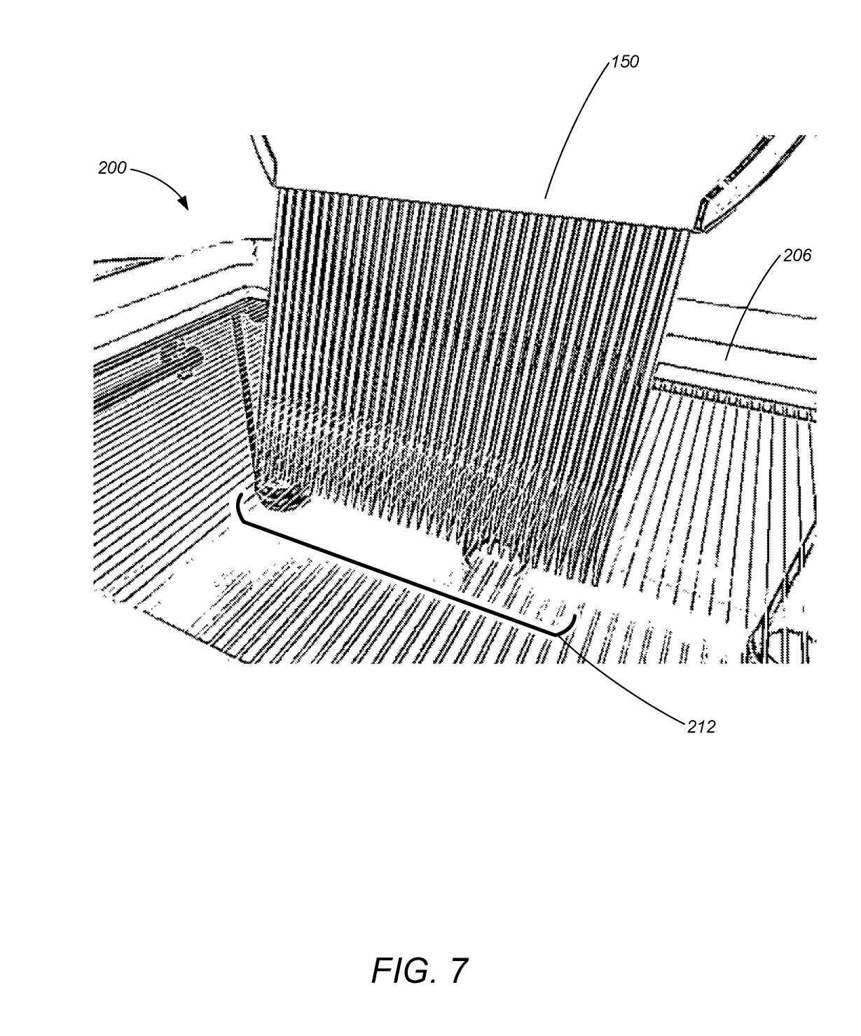

In an exemplary embodiment, the strands 212 may comprise of nylon, polypropylene, polyamide, polyester, silk, steel, polytetrafluoroethylene, although other materials that display suitable physical properties are also contemplated. The strands 212 may be attached to opposing sides of the opening 210 and may be arranged substantially parallel to each other. Strands at angles to each other may also be possible which may help ease cleaning of front and back edges. As best seen in FIG. 7, the strands 212 may be spaced so that a lice tool, or parts thereof may fit between the strands 212. The strands 212 may be flexible to so as to allow the lice tool, or parts thereof, to pass between them. By way of a non-limiting example, as best seen in FIG. 7, the strands 212 may be spaced so that one of the strands 212 may fit within the space defined by adjacent tines of a nit comb. In an exemplary embodiment, (not shown) the strands 212 may be spaced so that two or more strands 212 may fit within the space defined by adjacent tines of a nit comb. It is contemplated that the strands 212 may be of a diameter that matches the distance between adjacent tines of the nit comb so that one strand 212 may simultaneously contact two adjacent tines of the nit comb. In an exemplary embodiment, two or more adjacent strands 212 may be configured to fit in the space defined by adjacent tines of the nit comb. Accordingly, at least one strand may make contact with one tine of the nit comb, while at least one of the adjacent strands may make contact with an adjacent tine of the nit comb. In this way various types of lice tools may be used with the cleaning device 200. The lice tool may be pulled side to side and may be twisted/rotated slightly during cleaning to help the strands contact more surfaces and clean each surface of the tool, though the front and back ends may also be wiped on a cloth. Generally, the most difficult surfaces to clean are those between the tines and the cleaning devices disclosed herein are particularly well adapted to easily and efficiently cleaning surfaces between the tines of a tool.

The lower portion 204 may form a container, basin, collection area, etc. that may collect debris, ectoparasites, eggs/nits, other materials, etc. that are cleaned from the tool being cleaned. For example, as the tool is passed through or along the cleaning surface(s), opening, strands, etc. dislodged debris, ectoparasites, eggs/nits, other materials, etc. may fall from the tool into the lower portion 204. In one embodiment the frame and/or strands may be exchangable, e.g., as separate cartridges that may each be used at different times (e.g., between treatments or clients). Methods may include using one frame/cartridge, then removing it and replacing it with a new frame/cartridge with new strands. The dislodged debris, ectoparasites, eggs/nits, other materials, etc. from multiple treatments/clients may be able to collect in the bottom of the lower portion. The other lower portions of other embodiments described elsewhere herein may also function in a similar way. In one embodiment, a lid similar to upper portion 206 may be provided. The lid may be configured not to have an opening and may be used to contain dislodged debris, ectoparasites, eggs/nits, other materials, etc. until disposal. Optionally, the lid may form an air tight seal that can suffocate any living ectoparasites over time as air is not allowed to enter. Similar lids may be provided for other embodiments described elsewhere herein.

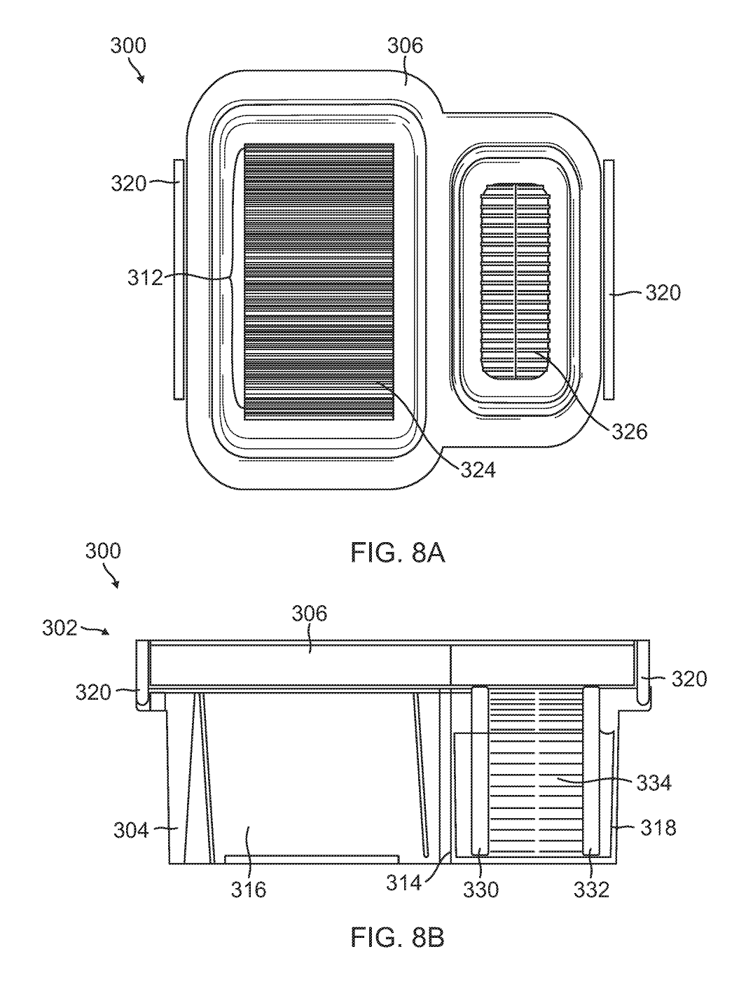

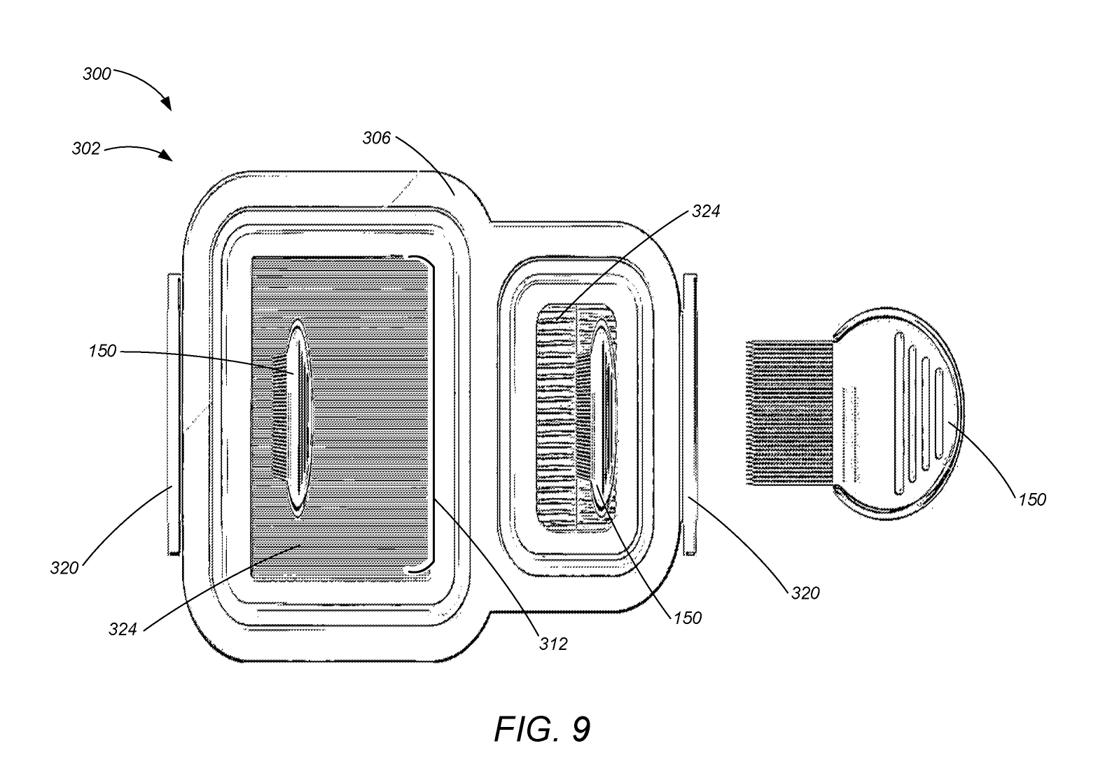

FIGS. 8A through 9 illustrate an exemplary embodiment of a cleaning device 300 similar to exemplary embodiments described herein. The cleaning device 300 may comprise substantially a box or container 302 that may include multiple portions (e.g., a first, base portion 304 and a second, upper portion 306. The upper portion 306 may be configured to engage the base portion 304 to create a seal therebetween. The cleaning device 300 may include at least one or multiple latches 320 or similar securing device to hold the base portion 304 and the upper portion 306 together, which may be similar to latch(es) described elsewhere herein. The cleaning device 300 may include at least one or multiple footing(s) (not shown, but may be similar to footings used with device 200), and may be made from different materials than that of the cleaning device 300 similar to exemplary embodiments described herein.

The base portion 304 may include a dividing wall 314 that defines a first receptacle 316 and a second receptacle 318. The upper portion 306 may include a first opening 324 and a second opening 326. When the upper portion 306 is secured to the base portion 304, the first opening the first opening 324 may substantially align with the first receptacle 316 and the second opening 326 may substantially align with the second receptacle 318.

The upper portion 306 may include a multiplicity of strands 312. As previously described in exemplary embodiments herein, the strands may, optionally, be disposed in a frame 208. The strands may be arranged in a similar way to the strands described elsewhere herein. The frame may be configured to align with the first opening 324 in substantially the same way as described in relation to the opening 210.

In an exemplary embodiment, the strands 312 may comprise of nylon, polypropylene, polyamide, polyester, silk, steel, polytetrafluoroethylene, although other materials that display suitable physical properties are also contemplated. The strands 312 may be configured in a similar way to those described in other exemplary embodiments herein. The frame 208 may be configured to fit with the upper portion 306 so that the strands 312 cover at least one or both of the first and second openings 324, 326. In an exemplary embodiment the frame 208 may be disposed between the upper portion 306 and the base portion 304. In an exemplary embodiment, at least one or both of the upper portion 306 or base portion 304 may include a rim 214 or edge that abuts against a portion of the frame. In an exemplary embodiment, the frame 208 includes at least one or multiple posts 216, which may be similar to posts described elsewhere herein. The post(s) 216 may be configured to dispose within a housing 218 disposed on at least one or both of the upper portion 306 or base portion 304. I will be appreciated that the configuration of rims 214, edges and posts 216 may vary between the frame 208, upper portion 306 or base portion 304 without departing from the spirit of the invention.

In an exemplary embodiment, the upper portion 306 may also include a first portion 330 and a second portion 332 that extend downwards, substantially perpendicular from the upper portion 306. Each of the first and second portions 330, 332 may include one or more cleaning surfaces. In a non-limiting example, each of the first and second portions 330, 332 may have a multiplicity of bristles disposed thereon configured similarly to those described herein in relation to the first and second brushes 124, 126.

In an exemplary embodiment, at least one or both of the first and second receptacles 316, 318 may include a fluid 334 to assist with the cleaning of the lice tool. For example, the fluid 334 may be disposed in either of the first and second receptacles 316, 318, or the fluid 334 may be disposed on at least one or multiple of the cleaning surfaces, or a combination thereof. By way of a non-limiting example, the fluid may include water, detergents, soaps, solvents, pesticides, other fluids described elsewhere herein, or the like. Similar fluid could also be used similarly in device 200.

In an exemplary method of use of the cleaning device 300, and as best seen in FIG. 9, a lice tool 150 such as, by way of a non-limiting example, a nit comb may be aligned substantially perpendicular to the strands 312 that align with the first opening 324 of the upper portion 306. As previously described herein, the strands 312 are configured so that, when the nit comb is pressed downwards through the first opening 324, at least one or multiple strands may be disposed in the space defined by adjacent tines of the comb. In this way each of the spaces defined by adjacent tines of the nit comb may have at least one strand disposed therein. A user may then move the comb downwards, through the first opening 324 until the strands 312 abut against the handle of the nit comb. The user may also draw the nit comb crossways, across the first opening 324. In this way the strands may contact the sides of the tines of the comb and remove any nits, eggs, or other debris disposed on the nit comb. While the device is configured so that only a single draw of the lice tool is needed, the process may be repeated as necessary. The tool may be pulled to either side and/or rotated/twisted slightly in different ways on different draws to help clean more surface area.

In an exemplary method of use of the cleaning device 300, and as best seen in FIG. 9, a lice tool 150 such as, by way of a non-limiting example, a nit comb may be aligned substantially perpendicular to the bristles disposed on the first and second portions 330, 332. In a similar method as described herein, the nit comb may be drawn downward and/or across the second opening 326. As previously described in relation to other embodiments, the bristles may be configured so as to fit the contours of the lice tool, such as, by way of a non-limiting example, between the tines of the nit comb. Either method of using the cleaning device 300 may be used alone or together in either order, and while the device is configured so that only a single draw of the lice tool is needed, the process may be repeated as necessary. The tool may be pulled to either side and/or rotated/twisted slightly in different ways on different draws to help clean more surface area.

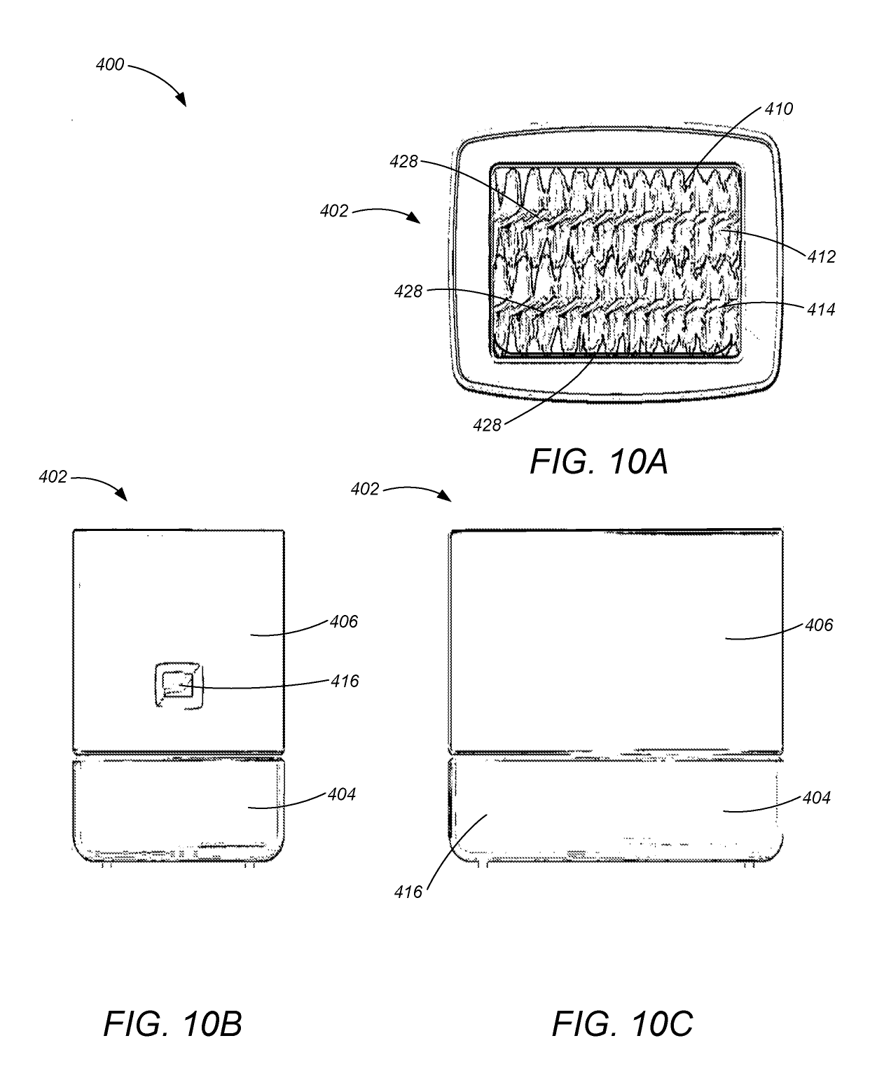

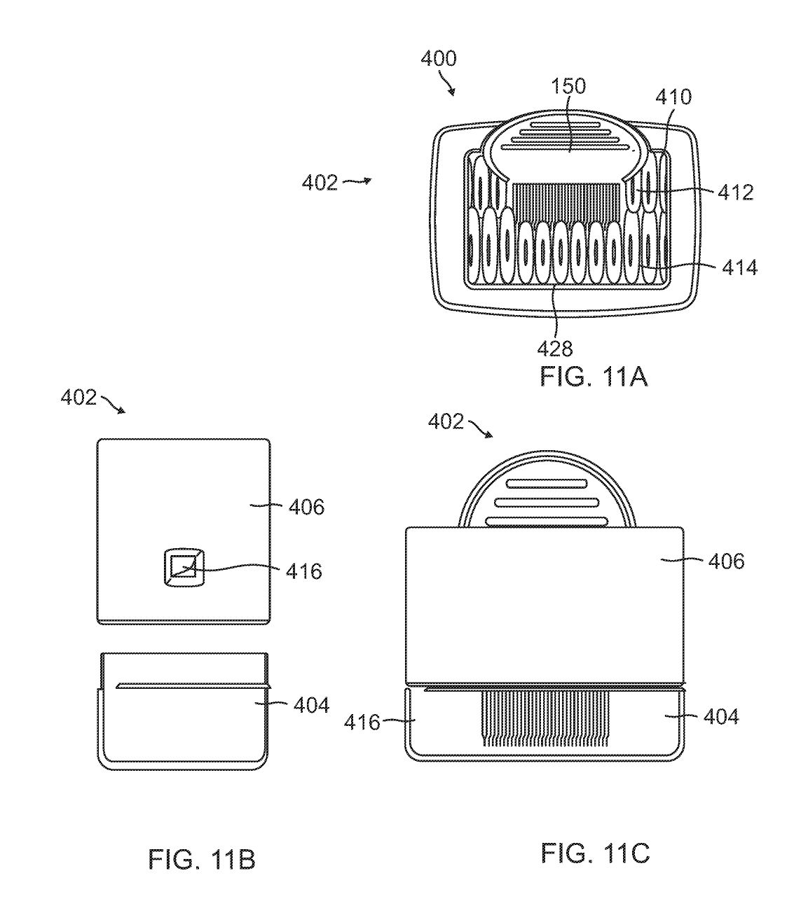

FIGS. 10A through 11C illustrate an exemplary embodiment of a cleaning device 400. The cleaning device 400 may be comprised substantially of a box or container 402 that may include multiple portions (e.g., a first, base portion 404 and a second, upper portion 406). The upper portion 406 may be configured to engage the base portion 404 to create a seal therebetween. The cleaning device 400 may include at least one or multiple latches (not shown) or similar securing device to hold the base portion 404 and the upper portion 406 together (the latch or latches may be similar to those used in other embodiments described herein). The cleaning device 400 may include at least one or multiple footings (not shown), which may be similar to those used on other embodiments described herein. As previously described herein in relation to exemplary embodiments, the footing(s) may be made from the same or a different material than that of the cleaning device 400 and may, by way of a non-limiting example, prevent the cleaning device from sliding on a work surface.

In an exemplary embodiment, the upper portion 406 may include an opening 410 in an upper surface of the upper portion 406, although it is contemplated that the opening 410 may also be configured in any part of either of the upper portion 406 or base portion 404 the cleaning device 400. The cleaning device 410 may also include at least one or multiple cleaning surfaces. In an exemplary embodiment shown in FIG. 10A the cleaning surface(s) of the cleaning device 400 may include a first brush 412 and a second brush 414. The first and second brushes 412, 414 may include a multiplicity of bristles 428 extending radially out from, and perpendicular to, a stem 426 and thus creating a substantially cylindrical profile. The first and second brushes 412, 414 may be configured to be accessed through opening 410. In a non-limiting example, as best seen in FIG. 10A, the first and second brushes 412, 414 may be aligned in a substantially horizontal orientation across the opening 410. The first and second brushes 412, 414 may be configured so that a portion of the first brush 412 overlap with a portion of the second brush 414. The bristles 428 of each brush may be configured in a similar way to other exemplary embodiments described herein.

Optionally, the first and second brushes 412, 414 may be coupled with a mechanism (not shown) that moves the brushes 412, 414. By way of a non-limiting example, the movement of the brushes 412, 414 may include rotation, vibration, a combination thereof, or the like. Something similar might also be used with other devices herein, e.g., device 100 or 300. In an exemplary embodiment, each brush 412, 414 may rotate in either clockwise or counter-clockwise direction, each brush 412, 414 may rotate in unison or in opposite directions from one another. The mechanism that moves the brushes 412, 414 may include a manual hand crank, electric motor, or similar mechanism that is known in the art. The mechanism may be powered by conventional means, as is known in the art.

In an exemplary embodiment, the cleaning device 400 may include one or more controls to operate the brushes 412, 414. As best seen in FIG. 11B, the controls may include a button 430 that a user may press in order to operate the mechanism to move the brushes 412, 414. It will be appreciated that other controls for operating the brushes 412, 414 fall within the scope of the present invention, such as, by way of a non-limiting examples, motion beam triggers, laser trip beam, pressure triggers, photo sensitive triggers, timers, or the like.

In an exemplary method of use of the cleaning device 400, and as best seen in FIGS. 11A and 11C, a lice tool 150 such as, by way of a non-limiting example, a nit comb, may be aligned substantially parallel to the stem 426 of either of the first or second brushes 412, 414. In a similar method as described above, the nit comb may be drawn downward and/or across the opening 410. The tool may be pulled to either side and/or rotated/twisted slightly in different ways on different draws to help clean more surface area. As previously described in relation to exemplary embodiments herein, the bristles 428 may be configured so as to fit the contours of the lice tool, such as, by way of a non-limiting example, between the tines of the nit comb. Either prior to or after the nit comb has been inserted into the opening 410, the controls may start the mechanism that will move the first and second brushes 412, 414. In an exemplary method of use, a user may depress the button 430 which may start an electric motor that may rotate the brushes 412, 414 to rotate in alternating clockwise and counterclockwise directions. The nit comb may be placed between the rotating brushes 412, 414, the brushes 412, 414 may then dislodge any nits, eggs or debris disposed on the nit comb downwards into the bottom portion 404 of the cleaning device 400. A fluid 416, similar to exemplary embodiments described herein, may be disposed either in the bottom portion, on the brushes 412, 414, or a combination thereof. The fluid 416 may include water, solvents, cleaning agents, a combination thereof, or the like. The fluid 416 may assist in the cleaning of the lice tool 150. In an exemplary embodiment, the cleaning device 400 itself may periodically need cleaning. As best seen in FIG. 11B, the bottom portion 404 may be detached from the upper portion 406 wherein the interior of the device may be accessed in order to clean the device.

In one exemplary embodiment, the device 400 may be beneficially used in combination with device 200 as a cleaning system that offers multiple types of cleaning, e.g., which could be similar to the combined first receptacle 316 and a second receptacle 318 of device 300, but as separated components/devices.

The various embodiments of cleaning devices described in this disclosure may include or be formed of housings, and one or more reservoirs may be enclosed in one or more of the housing(s) or other areas of the devices. The reservoir(s) may include a fluid or liquid (e.g., similar to those disclosed elsewhere herein) that might be used to help kill and/or remove ectoparasites and their eggs. The tool may be inserted into a reservoir(s), or the reservoir(s) may allow the fluid or liquid to be dispensable on one or more cleaning surfaces or on a treatment area of an animal (e.g., a head or portion of a head), e.g., a button, switch, pump, bubble, etc. may be pushed or toggled to cause fluid/liquid to dispense. (As one, non-limiting example, first and second portions 104, 108 may be formed of housings that enclose a reservoir that allows dispensing fluid onto the cleaning surface(s) or brush(es)).

Additionally or alternatively, the various embodiments and/or one or more cleaning surfaces of the various embodiments may include or comprise one or more heating devices that may be used to apply heat to a treatment area of an animal and/or to any ectoparasites and/or eggs in the treatment area, and/or the heat may be applied to one or more portions of a cleaning device described herein to kill/dehydrate any ectoparasites and/or eggs removed from the treatment area and included in and/or on a portion of the cleaning device. As some non-limiting examples, heated fluids/liquids, heated air, heated strands or brushes, heated surfaces, etc. may be used. The heat may beneficially kill or dehydrate the ectoparasites and/or eggs. Optionally, one or more portions of the various embodiments of cleaning devices herein may be configured and/or constructed of materials such that the one or more portions may be washed in hot water, washed in soapy water, boiled, washed in a dishwasher, and/or cleaned in other ways that will kill and/or remove any ectoparasites or eggs thereon.

The apparatuses, devices, systems, components, etc. described herein may be manufactured in a variety of ways, including using a mold or cast, injection molding, 3D printing, welding, carving, other methods, and/or a combination of these. All or some materials used to make the apparatuses, devices, systems, components, etc. discussed above may be polymer materials, polyurethane, silicone, latex, PVC, PTFE, wood, metals, rubber, nylon, latex, steel, aluminum, sponge, other materials disclosed herein, other materials not expressly disclosed, or a combination of some or all of these. Methods of manufacturing may include taking steps to form and/or combine/assemble components or features described in the order/arrangement(s) shown or described herein.

While generally described herein in terms of cleaning devices for cleaning tools used to treat an infestation, the principles and design features described may also be used with different types of tools used for other purposes, e.g., combs/brushes used for styling hair or other tools.

The cleaning devices and components thereof described herein may be used in a variety of methods. Methods of using the cleaning devices or any of their components may include any of the steps discussed anywhere in this description or the summary. These and other steps may be performed in the order disclosed or in a different sequence, and steps may be omitted or added. A cleaning system according to this disclosure may include one or more of the components and/or devices described herein in any combination.

While the invention has been described in terms of particular variations and illustrative figures, those of ordinary skill in the art will recognize that the invention is not limited to the variations or figures described. The features described with respect to one embodiment or variation may be used in other embodiments or variations. Methods described separately may be combined. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent will cover those variations as well. Therefore, the present disclosure is to be understood as not limited by the specific embodiments described herein, but only by scope of the appended claims

What is claimed is:

1. A cleaning device to clean a tool, comprising:
a first portion;
a second portion configured to engage the first portion; and
a cleaning surface configured for cleaning the tool, wherein the cleaning surface comprises at least one of bristles and strands, and wherein the cleaning surface is configured to engage the tool.

2. The cleaning device of claim 1, wherein the second portion includes a first opening, and wherein the cleaning surface is configured to engage the tool when the tool is passed through the first opening.

3. The cleaning device of claim 2, wherein the second portion further includes a second opening, and wherein a second, different cleaning surface is configured to engage the tool when the tool is passed through the second opening.

4. The cleaning device of claim 2, wherein the first opening is between 5 and 15 centimeters across.

5. The cleaning device of claim 2, wherein the cleaning surface includes multiple strands that extend across the first opening.

6. The cleaning device of claim 5, wherein the multiple strands are arranged parallel to each other.

7. The cleaning device of claim 5, wherein tool is a lice comb including multiple tines, and wherein the multiple strands are spaced relative to each other such that when the lice comb is inserted through the first opening, at least one strand of the multiple strands passes between each pair of tines of the multiple tines.

8. The cleaning device of claim 5, wherein the multiple strands are connected to a frame or cartridge that is removably enclosable between the first and second portions.

9. The cleaning device of claim 1, wherein the cleaning device includes a fluid that contacts the cleaning surface, wherein the fluid comprises chemicals for killing ectoparasites.

10. The cleaning device of claim 1, wherein the cleaning surface is rotatable.

11. The cleaning device of claim 1, wherein the first portion is hingedly attached to the second portion.

12. The cleaning device of claim 1, wherein the cleaning surface is at least one of a brush and a comb.

13. The cleaning device of claim 1, wherein the first portion is movable relative to the second portion from a first closed position to a second open position.

14. The cleaning device of claim 13, wherein in the second open position, the first portion is angled between 30 and 70 degrees relative to the second portion.

15. The cleaning device of claim 1, wherein the tool is a lice tool, and the cleaning surface is configured to engage the lice tool.

16. The cleaning device of claim 1, wherein the lower portion is configured as a collection container that is able to collect materials dislodged from the tool during cleaning.

17. A method for cleaning a tool, comprising:
obtaining a cleaning system including a first cleaning surface comprising multiple strands extending across an opening; and
drawing the tool across the first cleaning surface such that multiple surfaces of the tool contact different strands of the multiple strands.

18. The method of claim 17, wherein the tool is a lice tool with multiple tines, and wherein drawing the tool across the first cleaning surface such that multiple surfaces of the tool contact different strands of the multiple strands includes drawing the lice tool across the first cleaning surface such that the different strands of the multiple strands pass between different pairs of tines of the multiple tines.

19. The method of claim 17, wherein the cleaning system includes a second cleaning surface comprising multiple bristles, and wherein the tool is drawn across the first cleaning surface and then the tool is drawn across the second cleaning surface.

20. The method of claim 18, wherein at least one of the first cleaning surface and the second cleaning surface further includes a liquid thereon that includes chemicals for killing ectoparasites, and wherein drawing the tool across the first cleaning surface or drawing the tool across the second cleaning surface includes bringing the tool into contact with the liquid.
